(19) United States
(12) Patent Application Publication
(10) Pub. No.: US 2014/0286040 A1
(43) Pub. Date: Sep. 25, 2014

(54) Lamp and Luminaire

(71) Applicant: Toshiba Lighting & Technology Corporation, Yokosuka-shi (JP)

(72) Inventors: Soichi Shibusawa, Yokosuka-shi (JP); Yumiko Hayashida, Yokosuka-shi (JP); Seiko Kawashima, Yokosuka-shi (JP); Kozo Uemura, Yokosuka-shi (JP); Tomohiro Matsuo, Yokosuka-shi (JP); Yuiko Nakagawa, Yokosuka-shi (JP)

(73) Assignee: TOSHIBA LIGHTING & TECHNOLOGY CORPORATION, Yokosuka-shi (JP)

(21) Appl. No.: 14/032,601

(22) Filed: Sep. 20, 2013

(30) Foreign Application Priority Data
Mar. 25, 2013 (JP) 2013-062333

(51) Int. Cl. F21K 99/00

(52) U.S. Cl. CPC F21K 9/52
USPC 362/555

(57) ABSTRACT

A lamp according to an embodiment includes a plurality of light-emitting sections including a plurality of kinds of light-emitting elements provided side by side in a predetermined direction on a substrate and configured to respectively emit lights of different colors, luminous fluxes of the lights respectively emitted by the light-emitting elements being separately controllable. The lamp according to the embodiment includes a pipe configured to diffuse the lights emitted by the light-emitting elements and formed including a translucent material, linear transmittance of which is any value of 0% to 50%. A distance “d” from a lower part of the pipe to the light-emitting elements is larger than the inner radius of the pipe.

### CROSS-REFERENCE TO RELATED APPLICATIONS

This application is based upon and claims the benefit of priorities from Japanese Patent Application No. 2013-062333, filed on Mar. 25, 2013; the entire contents of which are incorporated herein by reference.

### FIELD

Embodiments described herein generally relate to a lamp and a luminaire.

### BACKGROUND

In recent years, a chip-on-board (COB) type including a plurality of LED chips mounted on a substrate is generally adopted as an LED (light-emitting diode) module.

Some light-emitting module of the COB type is used as a light source in a bulb type LED lamp of an assembly mounting type in which a flow stop is formed on a substrate collectively mounted with a plurality of LED chips and phosphor resin is poured into and hardened in the space formed by the flow stop. In recent years, a light-emitting module in which LED chips are provided side by side in a row at equal intervals on a substrate has also introduced into the market. In a straight tube type LED lamp, a plurality of light-emitting modules are connected and used.

However, in the direct tube type LED lamp, since a bright place and a dark place are sometimes formed, variance in brightness sometimes occurs.

### BRIEF DESCRIPTION OF THE DRAWINGS

FIG. 1 is a perspective view of a lighting device according to a first embodiment;

FIG. 2 is a sectional view of the lighting device shown in FIG. 1;

FIG. 3 is a connection diagram of the lighting device shown in FIG. 1;

FIG. 4 is a diagram of an example of a light-emitting module;

FIG. 5 is a diagram for explaining the position of a substrate in a pipe;

FIG. 6 is a sectional view of the light-emitting modules taken along line F7-F7 in FIG. 4;

FIG. 7 is a schematic diagram of the configuration of a sealing member included in the light-emitting module;

FIG. 8 is a diagram for explaining a relation among the distance between a pair of light-emitting elements, the distance between a pair of two kinds of light-emitting elements and a pair adjacent to the pair, and the outer diameter of the pipe;

FIG. 9 is a diagram for explaining a relation among the distance between a pair of light-emitting elements, the distance between a pair of two kinds of light-emitting elements and a pair adjacent to the pair, and the outer diameter of the pipe; and

FIG. 10 is a diagram for explaining an experiment.

### DETAILED DESCRIPTION

It is an object of the embodiments to provide a lamp and a luminaire that can suppress variance in brightness.

A lamp according to embodiments is explained below with reference to the drawings. Components having the same functions in the embodiments are denoted by the same reference numerals and signs and redundant explanation of the components is omitted. The lamp explained in the embodiments below only indicates an example and does not limit the present invention. The embodiments may be combined as appropriate as long as the combinations are not contradictory.

In first to third embodiments explained below, a lamp includes a plurality of light-emitting sections including a plurality of kinds of light-emitting elements provided side by side in a predetermined direction on a substrate and configured to respectively emit lights of different colors, luminous fluxes of the lights respectively emitted by the light-emitting elements being separately controllable. The lamp according to the embodiments includes a pipe configured to diffuse the lights emitted by the light-emitting elements and formed including a translucent material, linear transmittance of which is any value of 0% to 50%. In the lamp according to the embodiments, the distance from a lower part of the pipe to the light-emitting elements is larger than the inner radius of the pipe. Consequently, the distance from the light-emitting elements to the surface of the pipe by which the lights emitted by the light-emitting elements are diffused and output is large. Therefore, variance in brightness of light emitted from the pipe is suppressed.

In the lamp according to the first to third embodiments explained below, it is preferable that the distance between the light-emitting elements of the same kind that emit lights of the same color in different ones of the light-emitting sections is smaller than the inner diameter of the pipe. Therefore, since the distance between the light-emitting elements that emit the lights of the same color is small with respect to the inner diameter of the pipe, variance in brightness of the light emitted from the pipe is further suppressed.

In the first to third embodiments explained below, it is preferable that the plurality of kinds of light-emitting elements are, for example, two kinds of the light-emitting elements. In this case, in the first to third embodiments explained below, one kind of the light-emitting elements of the two kinds of light-emitting elements are connected to a first pole of a first power supply via a first wire and connected to a second pole via a second wire. The other kind of the light-emitting elements are connected to a first pole of a second power supply via a third wire and connected to the second pole via the second wire. Consequently, in both the two kinds of light-emitting elements, the second wire is used in common. Therefore, the number of wires is small, the internal structure of the lamp is made compact.

In the lamp according to the first to third embodiments explained below, it is preferable that the first pole is a positive pole and the second pole is a negative pole.

In the first to third embodiments explained below, it is preferable that the pipe is formed including a translucent material, linear transmittance of which is any value of 0% to 50%. Preferably, the pipe is formed including a translucent material, linear transmittance of which is any value of 0% to 20%.

In the second embodiment explained below, it is preferable that a difference between color temperatures of the lights respectively emitted from the plurality of kinds of light-emitting elements is equal to or larger than 1800 K, and the distance between the plurality of kinds of light-emitting elements in the light-emitting sections is smaller than the distance between the light-emitting sections. Consequently, the distance between the light-emitting elements that emit the lights of the different colors is small with respect to the distance between the light-emitting sections. Therefore, variance in brightness of the light emitted from the pipe is suppressed.

In the lamp in the second embodiment explained below, it is preferable that the distance between the light-emitting sections is smaller than a multiplication value of the outer diameter of the pipe and 0.6. Consequently, the distance between the light-emitting elements is small with respect to a value based on the outer diameter of the pipe. Therefore, variance in brightness of the light emitted from the pipe is suppressed.

In the third embodiment explained below, a color temperature of lights emitted by one kind of the light-emitting elements of the two kinds of light-emitting elements is lower than a predetermined color temperature, a color temperature of lights emitted by the other kind of the light-emitting elements is higher than the predetermined color temperature, and, in a state in which lights are emitted from both the light-emitting elements of the two kinds of light-emitting elements, when luminous fluxes of lights emitted from the respective light-emitting elements of the two kinds of light-emitting elements are controlled, a color temperature of the lights emitted from the light-emitting sections reaches the predetermined color temperature. Therefore, with the lamp including the light-emitting sections including the two kinds of light-emitting elements, it is possible to suppress variance in a color of the light emitted from the lamp.

In the first to third embodiments explained below, a luminaire includes: a lamp including a substrate, a plurality of light-emitting sections including a plurality of kinds of light-emitting elements provided side by side in a predetermined direction on the substrate and configured to respectively emit lights of different colors, luminous fluxes of the lights respectively emitted by the light-emitting elements being separately controllable, and a pipe configured to diffuse the lights emitted by the light-emitting elements and formed including a translucent material, linear transmittance of which is any value of 0% to 50%, the distance from a lower part of the pipe to the light-emitting elements being larger than the inner radius of the pipe; and a lighting circuit connected to a power supply and configured to supply electric power to the lamp. Therefore, variance in brightness of light emitted from the pipe is suppressed.

In the first to third embodiments explained below, for example, polycarbonate resin can be used as a resin material forming the pipe. However, the resin material is not limited to this and glass can also be used. The pipe is preferably formed by mixing an appropriate amount of a light diffusing agent in the resin material.

In the first to third embodiments explained below, as an example of a semiconductor light-emitting element, an LED chip can be cited. However, the semiconductor light-emitting element is not limited to this and, for example, a semiconductor laser and an EL (electro luminescence) element can also be used.

### First Embodiment

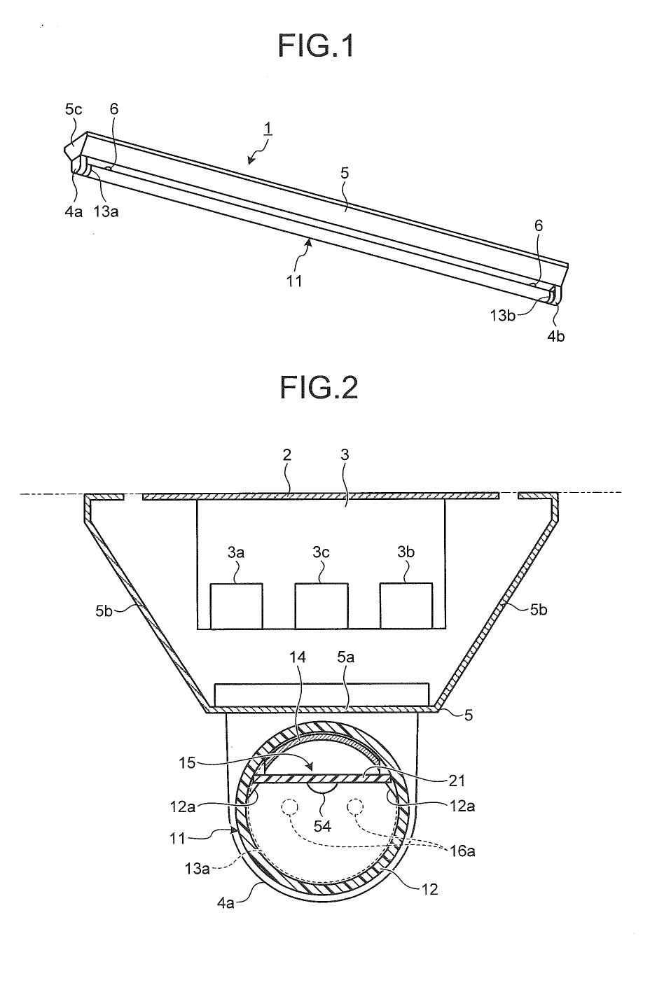

A direct tube type lamp and a luminaire for example, a lighting device, including the direct tube type lamp according to a first embodiment are explained with reference to FIGS. 1 to 7.

FIG. 1 is a perspective view of the lighting device according to the first embodiment. FIG. 2 is a sectional view of the lighting device shown in FIG. 1. In FIGS. 1 and 2, reference numeral 1 illustrates a direct-mounted lighting device.

The lighting device 1 includes a luminaire main body (a device main body) 2, a lighting circuit 3, a pair of first and second sockets 4a and 4b, a reflecting member 5, and a direct tube type lamp 11 forming a light source.

The luminaire main body 2 shown in FIG. 2 is made of, for example, a metal plate having an elongated shape. The luminaire main body 2 extends in a front back direction of the paper surface on which FIG. 2 is drawn. The luminaire main body 2 is fixed to, for example, the indoor ceiling using a not-shown plurality of screws.

The lighting circuit 3 is fixed in an intermediate section in the longitudinal direction of the luminaire main body 2. The lighting circuit 3 includes a first lighting circuit 3a, a second lighting circuit 3b, and a control circuit 3c.

The first lighting circuit 3a receives a commercial alternating-current power supply, generates a direct-current output, and supplies the direct-current output to below-mentioned light-emitting elements 45a of the lamp 11 according to the control by the control circuit 3c. The second lighting circuit 3b receives the commercial alternating-current power supply, generates a direct-current output, and supplies the direct-current output to below-mentioned light-emitting elements 45b of the lamp 11 according to the control by the control circuit 3c.

The control circuit 3c controls electric currents flowing to the light-emitting elements 45a and the light-emitting elements 45b having different emitted light colors and controls luminous fluxes of lights respectively emitted from the light-emitting elements 45a and the light-emitting elements 45b. Consequently, the control circuit 3c controls a color and brightness of light obtained by mixing the lights emitted from the light-emitting elements 45a and the lights emitted from the light-emitting elements 45b. Specifically, the control circuit 3c controls the magnitude of an electric current supplied from the first lighting circuit 3a to the light-emitting elements 45a, controls the magnitude of an electric current supplied from the second lighting circuit 3b to the light-emitting elements 45b, and controls a color and brightness of the light obtained by mixing the lights emitted from the light-emitting elements 45a and the lights emitted from the light-emitting elements 45b.

A power supply terminal table, a plurality of member supporting fittings, a pair of socket supporting members, and the like not shown in the figure are attached to the luminaire main body 2. A power supply line for the commercial alternating-current power supply drawn in from the attic is connected to the power supply terminal table. Further, the power supply terminal table is electrically connected to the lighting circuit 3 through not-shown intra-device wiring.

The sockets 4a and 4b are coupled to the socket supporting members and respectively disposed at both end portions in the longitudinal direction of the luminaire main body 2. The sockets 4a and 4b are sockets of a rotary mounting type.

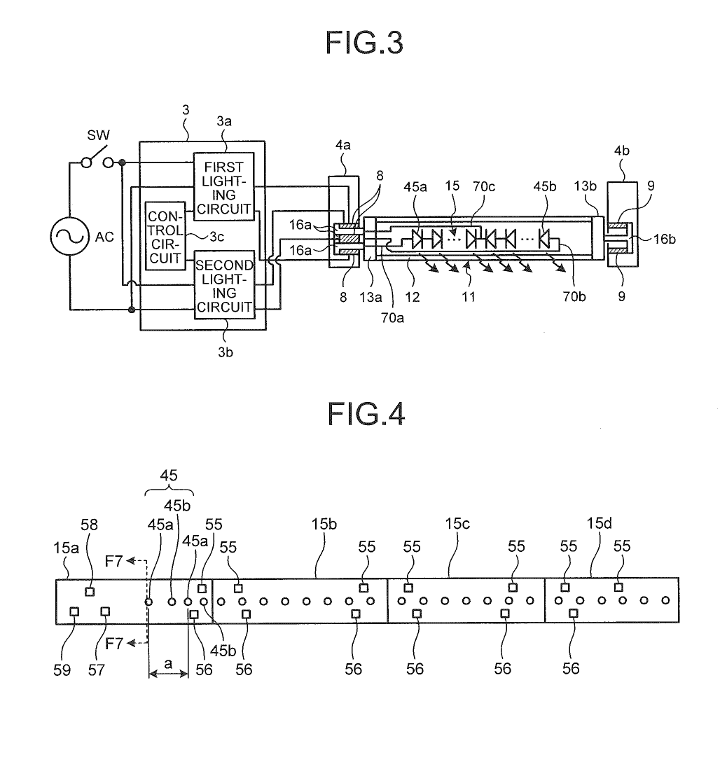

FIG. 3 is a connection diagram of the lighting device shown in FIG. 1. As shown in FIG. 3, the sockets 4a and 4b include pairs of terminal fittings 8 and 9 to which below-mentioned lamp pins 16a and 16b are connected. In order to supply electric power to the lamp 11, two terminal fittings 8 among three terminal fittings 8 of the first socket 4a are connected to the first lighting circuit 3a via the intra-device wiring. Two terminal fittings 8 among the three terminal fittings 8 of the first socket 4a are connected to the second lighting circuit 3b via the intra-device wiring. No wire is connected to the terminal fittings 9 of the second socket 4b.

As shown in FIG. 2, the reflecting member 5 includes, for example, a bottom plate section 5a, side plate sections 5b, and an end plate 5c made of metal and is formed in a trough shape opened in the upper surface. The bottom plate section 5a is flat. The side plate sections 5b are bent obliquely upward from both ends in the width direction of the bottom plate section 5a. The end plate 5c closes end face openings formed by ends in the longitudinal direction of the bottom plate section 5a and the side plate sections 5b. A metal plate forming the bottom plate section 5a and the side plate sections 5b are made of a color steel plate, the surface of which assumes a whitish color. Therefore, the surfaces of the bottom plate section 5a and the side plate sections 5b are reflection surfaces. Not-shown socket through-holes are respectively opened at both end portions in the longitudinal direction of the bottom plate section 5a.

The reflecting member 5 covers the luminaire main body 2 and components attached to the luminaire main body 2. This state is retained by detachable decoration screws (see FIG. 1) 6. The decoration screws 6 pierce through the bottom plate section 5a upward and are screwed into the member supporting fittings. The decoration screws 6 can be turned by a hand without using a tool. The sockets 4a and 4b are projected to the lower side of the bottom plate section 5a through the socket through-holes.

The lighting device 1 is not limited to a configuration for supporting only one lamp 11 explained below. For example, the lighting device 1 can include two pairs of sockets to support two lamps 11.

The lamp 11 detachably supported by the sockets 4a and 4b is explained below with reference to FIGS. 2 to 7.

The lamp 11 has a dimension and an outer diameter same as the dimension and the outer diameter of an existing fluorescent lamp. The lamp 11 includes a pipe 12, a first cap 13a and a second cap 13b attached to both ends of the pipe 12, a beam 14, a plurality of, for example, four light-emitting modules 15. When the four light-emitting modules 15 are distinguished, the light-emitting modules 15 are shown in the figures and explained with suffixes “a” to “d” added thereto.

The pipe 12 is formed of a translucent resin material in, for example, a long shape. As the resin material forming the pipe 12, polycarbonate resin mixed with a light diffusing agent can be suitably used. The diffuse transmittance of the pipe 12 is preferably 90% to 95%. The pipe 12 is formed including a translucent material, linear transmittance of which is any value of 0% to 50%. Preferably, the pipe 12 is formed including a translucent material, linear transmittance of which is any value of 0% to 20%. As shown in FIG. 2, the pipe 12 includes a pair of convex portions 12a on the inner surface of the region, which is an upper part of the pipe 12 in a state of use of the pipe 12.

The first cap 13a is attached to one end portion in the longitudinal direction of the pipe 12. The second cap 13b is attached to the other end portion in the longitudinal direction of the pipe 12. The first and second caps 13a and 13b are detachably connected to the sockets 4a and 4b. According to the connection, the lamp 11 supported by the sockets 4a and 4b is arranged right under the bottom plate section 5a of the reflecting member 5. A part of light emitted to the outside from the lamp 11 is made incident on the side plate sections 5b of the reflecting member 5.

As shown in FIG. 3, the first cap 13a includes the three lamp pins 16a projecting to the outside of the first cap 13a. The lamp pins 16a are electrically insulated from one another. The distal end portions of the three lamp pins 16a are bent at a substantially right angle and formed in an L shape to separate from one another. As shown in FIG. 3, the second cap 13b includes the one lamp pin 16b projecting to the outside of the second cap 13b. The lamp pin 16b includes a columnar shaft section and a distal end section provided at the distal end portion of the columnar shaft section and having an elliptical shape or an oval shape as a front shape (not shown in the figure) and is formed in a T shape on a side surface.

The three lamp pins 16a of the first cap 13a are connected to the three terminal fittings 8 of the socket 4a and the lamp pins 16b of the second cap 13b are connected to the terminal fittings 9 of the socket 4b, whereby the lamp 11 is mechanically supported by the sockets 4a and 4b. In this supported state, power supply to the lamp 11 is enabled by the terminal fittings 8 in the socket 4a and the lamp pins 16a of the first cap 13a that are in contact with the terminal fittings 8.

The light-emitting elements 45a that emit lights of the same color are connected in series. An anode side of diodes of the light-emitting elements 45a is connected to a positive pole of the first lighting circuit 3a by a wire 70a, which is an example of the first wire. A cathode side of the diodes of the light-emitting elements 45a is connected to a negative pole of the first lighting circuit 3a by a wire 70c, which is an example of the second wire. The light-emitting elements 45b that emit lights of the same color are connected in series. An anode side of diodes of the light-emitting elements 45b is connected to a positive pole of the second lighting circuit 3b by a wire 70b, which is an example of the third wire. A cathode side of the diodes of the light-emitting elements 45b is connected to a negative pole of the second lighting circuit 3b by the wire 70c. That is, in this embodiment, one kind of the light-emitting elements 45a of the two kinds of light-emitting elements 45a and 45b are connected to the positive pole of the first lighting circuit 3a, which is an example of the first power supply, via the wire 70a and connected to the negative pole via the wire 70b. The other kind of the light-emitting elements 45b are connected to the positive pole of the second lighting circuit 3b, which is an example of the second power supply, via the wire 70c and connected to the negative pole via the wire 70b. Consequently, in both the two kinds of light-emitting elements 45a and 45b, the wire 70b is used in common. Therefore, since the number of wires is small, the internal structure of the lamp 11 is made compact.

As shown in FIG. 2, the beam 14 is housed in the pipe 12. The beam 14 is a bar material excellent in mechanical strength. For a reduction in weight, the beam 14 is formed of, for example, an aluminum alloy. Both ends in the longitudinal direction of the beam 14 are electrically insulated from and coupled to the first cap 13a and the second cap 13b.

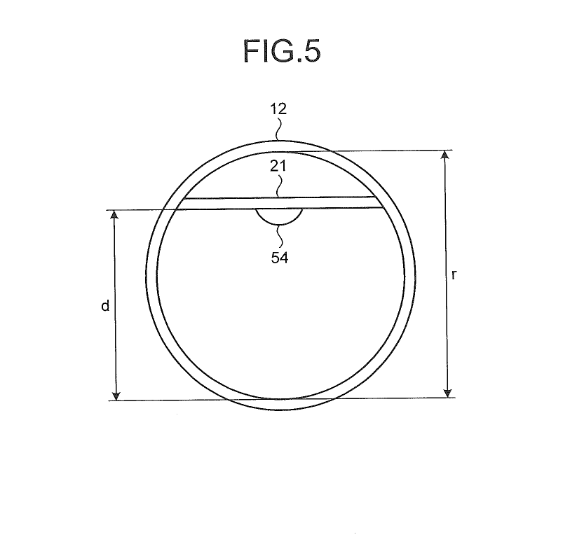

FIG. 4 is a diagram of an example of light-emitting modules. As shown in FIG. 4, all four light-emitting modules 15a to 15d are formed in an elongated rectangular shape and arranged in a straight row. The length of the light-emitting module row is substantially equal to the total length of the beam 14. The light-emitting modules 15a to 15d are fixed by not-shown screws screwed into the beam 14.

Therefore, the light-emitting modules 15a to 15d are housed in the pipe 12 together with the beam 14. In this supported state, both end portions in the width direction of the light-emitting modules 15a to 15d are placed on the convex portions 12a of the pipe 12. Consequently, the light-emitting modules 15a to 15d are substantially horizontally disposed further on the upper side than the maximum width in the pipe 12.

Each of the light-emitting modules 15a to 15d includes a substrate 21 and a plurality of light-emitting sections 45 each including two kinds of light-emitting elements (the light-emitting elements 45a and the light-emitting elements 45b) forming a pair that emit lights of different colors. The plurality of light-emitting sections 45 including the light-emitting elements 45a and the light-emitting elements 45b are provided side by side in a predetermined direction on the substrate 21. Luminous fluxes of lights respectively emitted by the light-emitting elements 45a and the light-emitting elements 45b are separately controllable. That is, the luminous fluxes of the lights respectively emitted by the light-emitting elements 45a and the light-emitting elements 45b are separately controlled by the control circuit 3c. For example, the light-emitting elements 45a emit blue light and the light-emitting elements 45b emit yellow light.

The position of the substrate 21 in the pipe 12 is explained with reference to FIG. 5. FIG. 5 is a diagram for explaining the position of the substrate 21 in the pipe 12. In this embodiment, as indicated by an example shown in FIG. 5, when the diameter of the inside (the inner diameter) of the pipe 12 is represented as “r” and the distance from the bottom portion on the inside of the pipe to the substrate 21 is represented as “d”, the position of the substrate 21 in the pipe 12 is represented by the following Expression (1):

r/2<d (1)

That is, the substrate 21 is disposed further on the upper side than the maximum width portion (the center portion) in the pipe 12. Accordingly, the light-emitting modules 15a to 15d are also disposed further on the upper side than the maximum width portion in the pipe 12. Therefore, compared with a configuration in which the light-emitting modules 15a to 15d are disposed further on the lower side than the maximum width in the pipe 12, the distance from the light-emitting elements 45a and 45b to the surface of the pipe 12 by which the lights emitted from the light-emitting elements 45a and 45b are diffused and output is large. Therefore, with the pipe 12 according to this embodiment, it is possible to suppress variance in brightness of the light emitted from the pipe 12.

In this embodiment, as indicated by an example shown in FIG. 4, when a distance between the light-emitting elements 45a of the same kind is represented as “a”, the size of the distance between light-emitting elements 45a of the same kind is represented by the following Expression (2x):

a<r (2)

That is, in this embodiment, the distance between the light-emitting elements 45a that emit lights of the same color is small with respect to the inner diameter “r” of the pipe 12. Therefore, with the pipe 12 according to this embodiment, variance in brightness of the light emitted from the pipe 12 is suppressed.

A value of the distance “a” between the light-emitting elements 45a is, for example, a value equal to or smaller than 12.3 mm. A value of the distance “d” from the bottom portion on the inside of the pipe 12 to the substrate 21 is, for example, a value equal to or larger than 15 mm.

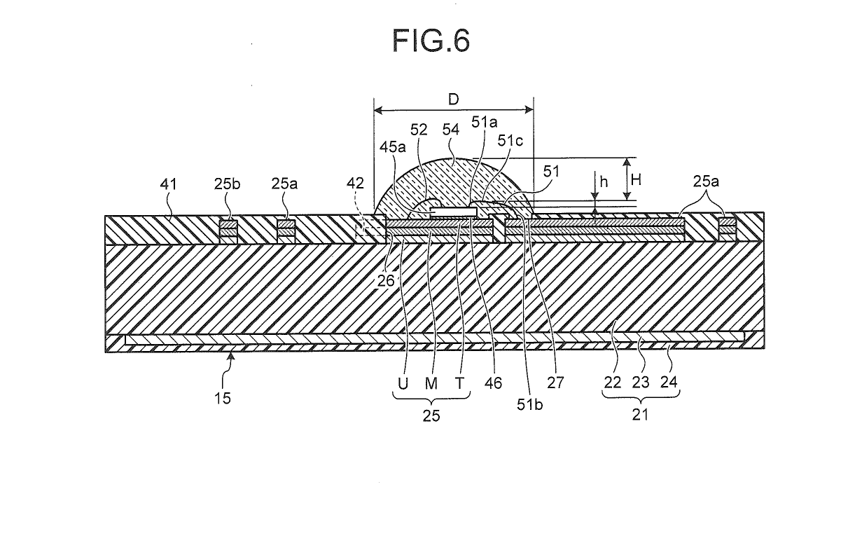

FIG. 6 is a sectional view of the light-emitting module taken along line F7-F7 in FIG. 4. A sectional view taken along a line passing the light-emitting element 45a is explained below. However, a sectional view taken along a line passing the light-emitting element 45b is the same. Therefore, explanation of the sectional view taken along the line passing the light-emitting element 45b is omitted.

As shown in FIG. 6, the light-emitting module 15 includes the substrate 21, a wiring pattern 25, a protection member 41, the light-emitting element 45a, a first wire 51, a second wire 52, a sealing member 54, and various electric components 55 to 59.

The substrate 21 is formed by a base 22, a metal foil 23, and a cover layer 24.

The base 22 is formed of a flat plate made of resin, for example, glass epoxy resin. A substrate of glass epoxy resin (FR-4) is low in heat conductivity and relatively inexpensive. The base 22 may be formed of a glass composite substrate (CEM-3) or other synthetic resin materials.

As shown in FIG. 6, the metal foil 23 is superimposed on the rear surface of the substrate 21 and is made of, for example, a copper foil. The cover layer 24 is superimposed over the peripheral rear surface of the base 22 and the metal foil 23. The cover layer 24 is made of an insulating material, for example, a resist layer made of synthetic resin. The substrate 21 is reinforced with a bend suppressed by the metal foil 23 and the cover layer 24 superimposed on the rear surface.

The wiring pattern 25 is formed on the surface of the base 22 (i.e., the surface of the substrate 21) in a three-layer structure. A first layer U is formed of plated copper on the surface of the base 22. A second layer M is plated on the first layer U and formed of nickel. A third layer T is plated on the second layer M and formed of silver.

Therefore, the surface of the wiring pattern 25 is made of silver. The third layer T made of silver forms a reflection surface. The total ray reflectance of the third layer T is equal to or higher than 90%.

As the protection member 41, for example, a white resist layer mainly containing electrically insulative synthetic resin can be suitably used. The white resist layer functions as a reflection layer having high light reflectance. The protection member 41 is formed on the substrate 21 to cover the most portion of the wiring pattern 25.

At a stage when the protection member 41 is formed on the substrate 21, mounting pads 26 and conductive connecting sections 27 are formed in a portion where the third layer T is exposed without being covered with the protection member 41. The mounting pads 26 are arranged in the longitudinal direction of the substrate 21. The conductive connecting sections 27 form pairs with the mounting pads 26 and are respectively disposed near the mounting pads 26. Therefore, the conductive connecting sections 27 are arranged in the longitudinal direction of the substrate 21 at a disposing pitch same as the disposing pitch of the mounting pads 26.

The light-emitting element 45a includes a bare chip of an LED. In the bare chip of the LED, a light-emitting layer is provided on one surface of an element substrate made of sapphire. A plane shape of the bare chip is a rectangular shape.

In the light-emitting element 45a, the other surface of the element substrate on the opposite side of the one surface is fixed to the mounting pad 26, which is a reflection surface, using an adhesive 46. The light-emitting element 45a forms a light-emitting element row arranged in the longitudinal direction of the substrate 21 (a direction in which a center axis extends).

A bonding place of the light-emitting element 45a is preferably the center of the mounting pad 26. Consequently, in a reflection surface region around the light-emitting element 45a, light irradiated from the light-emitting element 45a and made incident on the mounting pad 26 can be reflected.

In this case, the light made incident on the mounting pad 26 is more intense in a place closer to the light-emitting element 45a. The intense light can be reflected on the reflection surface region.

The light emission of the light-emitting element 45a including the bare chip of the LED is realized by feeding a forward direction current to p-n junction of a semiconductor. Therefore, the light-emitting element 45a is a solid-state element that converts electric energy into direct light. The light-emitting element 45a that emits light according to such a light emission principle has an energy saving effect compared with an incandescent lamp in which a filament is caused to glow at high temperature through energization and visible light is irradiated by heat radiation of the filament.

The adhesive 46 preferably has heat resistance in obtaining durability of bonding and further has translucency in order to enable reflection even right under the light-emitting element 45a. As such an adhesive 46, a silicone resin adhesive can be used.

The first wire 51 and the second wire 52 are made of metal thin wires, for example, gold thin wires and are wired using a bonding machine.

As shown in FIG. 6, the first wire 51 is provided to electrically connect the light-emitting element 45a and the conductive connecting section 27 of a first wiring pattern 25a. In this case, one end portion 51a of the first wire 51 is connected to an electrode of the light-emitting element 45a by first bonding. The other end portion 51b of the first wire 51 is connected to the conductive connecting section 27 by second bonding.

The one end portion 51a of the first wire 51 is projected in the thickness direction of the light-emitting element 45a and in a direction away from the light-emitting element 45a. The conductive connecting section 27 is shifted further to the substrate 21 side than the electrode of the light-emitting element 45a and the other electrode with respect to the thickness direction of the light-emitting element 45a. The other end portion 51b of the first wire 51 is obliquely connected to the conductive connecting section 27.

An intermediate portion 51c of the first wire 51 is a region between the one end portion 51a and the other end portion 51b. As shown in FIG. 6, the intermediate portion 51c is bent from the one end portion 51a and formed to be parallel to the light-emitting element 45a. Projection height “h” of the intermediate portion 51c with respect to the light-emitting element 45a is specified to be equal to or larger than 75 μm and equal to or smaller than 125 μm, preferably, equal to or larger than 60 μm and equal to or smaller than 100 μm. Consequently, the wire-bonded first wire 51 is wired with height kept low with respect to the light-emitting element 45a.

As explained above, the intermediate portion 51c and the other end portion 51b of the wired first wire 51 extend in a direction orthogonal to a direction in which the light-emitting element 45a forms a row. Such wiring is realized by the arrangement of the light-emitting element 45a with respect to the mounting pad 26. The length of the first wire 51 can be reduced by the wiring. Therefore, it is possible to reduce the costs of the first wire 51 compared with costs in wiring the first wire 51 obliquely to the light-emitting element 45a in plan view.

The second wire 52 is provided to connect, through wire bonding, the light-emitting element 45a and the mounting pad 26 made of a part of the first wiring pattern 25a. In this case, one end portion of the second wire 52 is connected to the other electrode of the light-emitting element 45a by first bonding. The other end portion of the second wire 52 is connected to the mounting pad 26 by second bonding.

Therefore, the plurality of light-emitting elements 45a mounted on the substrates 21 of the light-emitting modules 15 are electrically connected. A plurality of light-emitting element 45a groups mounted on the substrates 21 are also electrically connected. The plurality of light-emitting elements 45a emit lights when electric power is supplied from the first lighting circuit 3a.

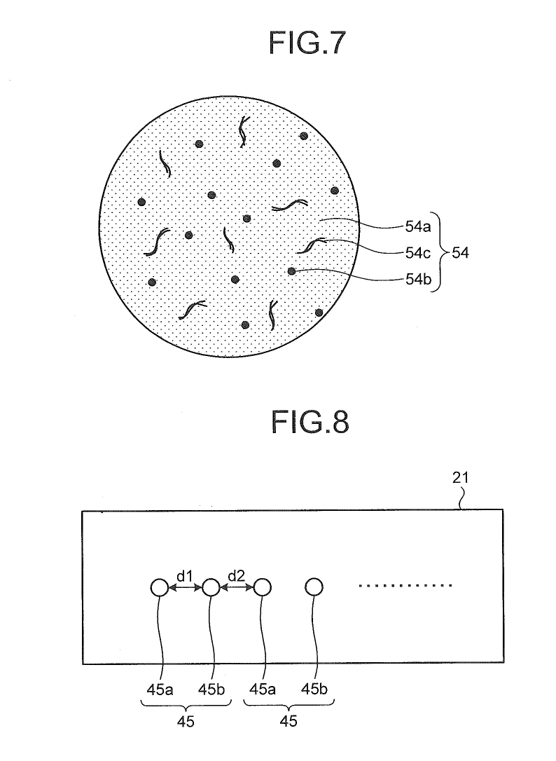

FIG. 7 is a schematic diagram of the configuration of a sealing member included in the light-emitting module. As schematically shown in FIG. 7, the sealing member 54 is formed by mixing appropriate amounts of a phosphor 54b and a filler 54c in resin 54a, which is a main component.

As the resin 54a, thermoplastic resin having translucency can be used. As the resin 54a, it is preferable to use, for example, silicone resin. The silicone resin has a three-dimensionally crosslinked composition. Therefore, the silicone resin is harder than translucent silicone rubber.

The phosphor 54b is excited by lights emitted by the light-emitting elements 45a and 45b and irradiates light of a color different from a color of the lights emitted by the light-emitting elements 45a and 45b. For example, when the light-emitting elements 45a emit blue light, as the phosphor 45b, a yellow phosphor that irradiates, through excitation, yellowish light in a complementary color relation with the blue light is used.

The sealing member 54 buries the mounting pad 26, the conductive connecting section 27, the light-emitting element 45a, the first wire 51, and the second wire 52 to thereby seal the same and is formed on the substrate 21. The sealing member 54 is dripped targeting the light-emitting element 45a in an unhardened state. Thereafter, the sealing member 54 is hardened and formed by being subjected to heat treatment. A dispenser or the like is used for the drip (potting) of the sealing member 54.

The hardened sealing member 54 is arranged on the substrate 21 at a predetermined interval in the longitudinal direction of the substrate 21 and disposed to form a sealing member row according to the row of the light-emitting element 45a. The hardened sealing member 54 is formed in a dome shape.

A diameter D (see FIG. 6) of the sealing member 54 is specified to 1.0 to 1.4 times as large as a pad diameter D1. In the case of this embodiment, the diameter D is 4.0 mm to 5.0 mm. Consequently, a part of the mounting pad 26 is suppressed from protruding from the sealing member 54.

Further, an amount of the sealing member 54 is not too large for the mounting pad 26. Therefore, it is possible to make an amount of use of the sealing member 54 appropriate while retaining a below-mentioned aspect ratio. In order to specify the height H and the diameter D of the sealing member 54, a frame or the like that surround the light-emitting element 45a and the like is absent. Therefore, the diameter D and the height H of the sealing member 54 are controlled according to an amount of drip of the sealing member 54, the harness of the sealing member 54, and time until the sealing member 54 is hardened.

The height H of the sealing member 54 with respect to the light-emitting element 45a is equal to or larger than 1.0 mm. In order to secure the height H equal to or larger than 1.0 mm, an aspect ratio of the sealing member 54 is set to 0.20 to 1.00. The aspect ratio of the sealing member 54 is a ratio (H/D) of the diameter D of the sealing member 54 to the height H of the sealing member 54 with respect to the light-emitting element 45a.

Further, a ratio of orthogonal diameters of the sealing member 54 is 0.55 to 1.00. The ratio of orthogonal diameters indicates a ratio of diameters X and Y orthogonal to each other of the bottom surface of the sealing member 54 bonded to the substrate 21. The diameter X is a diameter of the bottom surface of the sealing member 54 arbitrarily drawn to pass thorough the center of the light-emitting element 45a. The diameter Y is a diameter of the bottom surface of the sealing member 54 drawn to be orthogonal to the diameter X.

Referring back to FIG. 4, the electric components 55 shown in FIG. 4 are capacitors. The electric components 56 are connectors. The electric component 57 is a rectifying diode, i.e., a rectifying circuit. The electric component 58 is a resistor. The electric component 59 is an input connector. The mechanical component 57, which is the rectifying circuit, rectifies electric power supplied from the first lighting circuit 3a and the second lighting circuit 3b.

The electric components 55, which are the capacitors, are respectively mounted on the four light-emitting modules 15. For example, the capacitors are connected in parallel to the respective light-emitting element 45a groups and light-emitting element 45b groups.

The electric components 55 disposed in this way function as bypass elements that feed noise superimposed on the wiring pattern 25 of the light-emitting modules 15 bypassing the light-emitting groups. Consequently, superimposition of the noise on the light-emitting element groups is suppressed. Therefore, in a state in which a power supply is turned off by a switch SW shown in FIG. 3, it is possible to suppress dark lighting of the lamp 11 due to a flow of the noise to the light-emitting elements 45a and 45b.

In the light-emitting modules 15a and 15d disposed at both end portions in the longitudinal direction of the light-emitting module row, the electric components 56, which are the connectors, are mounted only at one end portions. Further, in the light-emitting modules 15b and 15c disposed between the light-emitting modules 15a and 15d, the electric components 56 are respectively mounted at both end portions in the longitudinal direction of the light-emitting modules 15b and 15c. The light-emitting element 45a groups of the light-emitting modules 15 are electrically connected in series and the light-emitting element 45b groups of the light-emitting modules 15 are electrically connected in series by the electric components 56.

The electric component 59, which is the input connector, is connected to the wiring pattern 25a of the light-emitting module 15a. Not-shown electric wires connected to the electric component 59 are respectively connected to the lamp pins 16a of the first cap 13a disposed closer to the electric component 59.

The switch SW is turned on in a state in which both ends of the direct tube type lamp 11 having the above-mentioned configuration are supported by the sockets 4a and 4b of the lighting device 1, whereby electric power is supplied from the first socket 4a to the first cap 13a of the lamp 11 through the first lighting circuit 3a and the second lighting circuit 3b. The light-emitting elements 45a and the light-emitting elements 45b emit lights all at once according to the power supply. According to the emission of the lights, light emitted from the sealing member 54 is diffused by the pipe 12 and transmitted through the pipe 12 and emitted to the outside. Consequently, a lower space of the lamp 11 is illuminated. At the same time, a part of the light emitted from the pipe 12 is reflected by the side plate sections 5b of the reflecting member 5 and illuminates, for example, a space further on the upper side than the lamp 11.

As explained above, the lamp 11 according to the first embodiment includes the plurality of light-emitting sections 45 including the plurality of kinds of light-emitting elements 45a and 45b provided side by side in the predetermined direction on the substrate 21 and configured to emit lights of different colors, luminous fluxes of the emitted lights being separately controllable. The lamp 11 according to the first embodiment includes the pipe 12 configured to diffuse lights emitted by the light-emitting elements 45a and 45b and formed including the translucent material, linear transmittance of which is any value of 0% to 50%. In the lamp 11 according to the first embodiment, the distance “d” from the lower part of the pipe 12 to the light-emitting elements 45a and 45b is larger than the inner radius (r/2) of the pipe 12. Therefore, the distance from the light-emitting elements 45a and 45b to the surface of the pipe 12 by which the lights emitted from the light-emitting elements 45a and 45b are diffused and output is large compared with the distance from the light-emitting elements 45a and 45b to the surface of the pipe 12 by which the lights emitted from the light-emitting elements 45a and 45b are diffused and output when the light-emitting module is disposed further on the lower side than the maximum width in the pipe 12. Therefore, with the pipe 12 according to this embodiment, it is possible to suppress variance in brightness of light emitted from the pipe 12.

In the lamp 11 according to the first embodiment, the distance between the light-emitting elements 45a that emit lights of the same color is small with respect to the inner diameter “r” of the pipe 12. Therefore, with the pipe 12 according to this embodiment, it is possible to further suppress variance in brightness of the light emitted from the pipe 12.

In this embodiment, the sealing member 54 formed by mixing appropriate amounts of the phosphor 54b and the filler 54c in the resin 54a, which is a main component, is formed on the light-emitting elements 45a and 45b in a dome shape. It is possible to emit light in a low position on a substrate surface compared with the SMD illuminant and distribute the light to a wide range. Therefore, in the lamp 11 according to this embodiment, when the light-emitting modules 15a to 15d are disposed further on the upper side than the maximum width portion in the pipe 12, light can be distributed to a wider range. Therefore, compared with the SMD illuminant, it is possible to suppress variance in brightness, variance in a color, and the like.

In the lamp 11 according to the first embodiment, one kind of the light-emitting elements 45a of the two kinds of light-emitting elements 45a and 45b are connected to the first pole of the first lighting circuit 3a via the wire 70a and connected to the second pole via the wire 70b. The other kind of the light-emitting elements 45b are connected to the first pole of the second lighting circuit 3b via the wire 70c and connected to the second pole via the wire 70b. Consequently, in both the two kinds of light-emitting elements 45a and 45b, the wire 70b is used in common. Therefore, since the number of wires is small, the internal structure of the lamp 11 is made compact.

In the lamp 11 according to the first embodiment, the first pole is the positive pole and the second pole is the negative pole.

In the lamp 11 according to the first embodiment, the pipe is formed including a translucent material, linear transmittance of which is any value of 0% to 50%. Preferably, the pipe 12 is formed including a translucent material, linear transmittance of which is any value of 0% to 20%.

### Second Embodiment

A second embodiment is explained. The second embodiment is different from the first embodiment in that the distance between the light-emitting elements 45a and the light-emitting elements 45b in the light-emitting sections 45, the distance between the light-emitting sections 45, and the diameter of the outside (the outer diameter) of the pipe 12 have a predetermined relation. Concerning the other points, the second embodiment is the same as the first embodiment. Therefore, explanation of the other points is omitted.

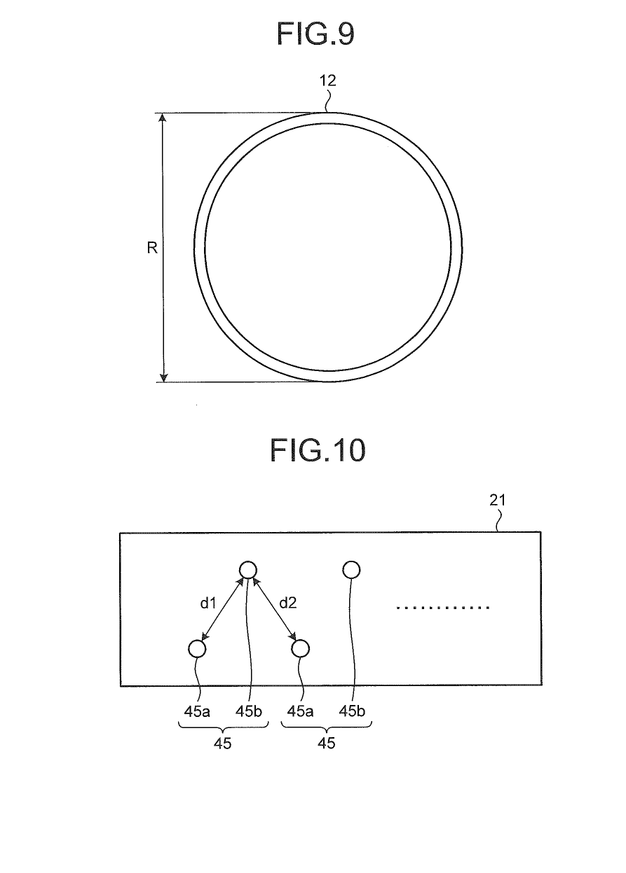

FIGS. 8 and 9 are diagrams for explaining a relation among the distance between the light-emitting elements 45a and the light-emitting elements 45b in the light-emitting sections 45, the distance between the light-emitting sections 45, and the outer diameter of the pipe 12.

As indicated by an example shown in FIG. 8, when the distance between the light-emitting elements 45a and the light-emitting elements 45b in the light-emitting sections 45 is represented as d1, the distance between the light-emitting sections 45 is represented as d2, and the outer diameter of the pipe 12 is represented as R as indicated by an example shown in FIG. 9, in this embodiment, a relation indicated by the following Expression (3) and Expression (4) is satisfied:

d2<0.6×R (3)

d1/d2<1 (4)

More preferably, in this embodiment, a relation indicated by the following Expression (5) instead of Expression (3) is satisfied:

d2<0.45×R (5)

That is, in this embodiment, the distance d1 between the two kinds of light-emitting elements 45a and 45b in the light-emitting sections 45 is smaller than the distance d2 between the light-emitting sections 45.

For example, when the relation is satisfied, the distance d1 between the light-emitting elements 45a and 45b that emit lights of the different color is small with respect to the distance d2 between the light-emitting elements 45a and 45b. Therefore, variance in a color of light emitted from the pipe 12 is suppressed.

In this embodiment, the distance d2 between the light-emitting sections 45 including the light-emitting elements 45a and the light-emitting elements 45b is smaller than a multiplication value of the outer diameter R of the pipe 12 and 0.6, preferably smaller than a multiplication value of the outer diameter R and 0.45. Consequently, the distance d2 between the light-emitting sections 45 is small with respect to a value based on the outer diameter R of the pipe 12. Therefore, variance in brightness of the light emitted from the pipe 12 is suppressed.

In this embodiment, the sealing member 54 formed by mixing appropriate amounts of the phosphor 54b and the filler 54c in the resin 54a, which is a main component, is formed on the light-emitting elements 45a and 45b in a dome shape. Therefore, it is possible to emit light in a low position on a substrate surface compared with the SMD illuminant and distribute the light to a wide range. Therefore, it is easy to mix the lights of the two kinds of colors emitted from the light-emitting elements 45a and 45b. It was found by an experiment that, when the relation of Expression (3) and Expression (4) or Expression (4) and Expression (5) is satisfied, in particular, when a difference between color temperatures of lights respectively emitted from the two kinds of light-emitting elements 45a and 45b is equal to or larger than 1800 K, variance in a color of the light emitted from the lamp 11 is reduced.

A part of content of the experiment is explained. First, a difference between a maximum value and a minimum value of a color temperature in the longitudinal direction of the pipe 12 of light output from the pipe 12 was measured using a light-emitting module in which light-emitting sections including two kinds of light-emitting elements, color temperatures of emitted lights of which were 3500 K and 5500 K, having a diameter (φ) of 5 mm and height of 1 mm were arranged in one row in the longitudinal direction of a substrate. In the light-emitting module, R=30 mm, d2=21 mm, and d1=8 mm. That is, the light-emitting module satisfies the relation indicated by Expression (4) but does not satisfy the relations indicated by Expression (3) and Expression (5). In a measurement result of the experiment, the difference between the maximum value and the minimum value of the color temperature of the light output from the pipe 12 was 300 K and variance of a color was conspicuous.

Subsequently, a difference between a maximum value and a minimum value of a color temperature in the longitudinal direction of the pipe 12 of light output from the pipe 12 was measured using a light-emitting module in which the light-emitting sections 45 including two kinds of light-emitting elements, color temperatures of emitted lights of which were 3500 K and 5500 K, having a diameter (φ) of 5 mm and height of 1 mm were arranged in one row in the longitudinal direction of a substrate as shown in FIG. 8. In the light-emitting module, R=30 mm, d2=12 mm, and d1=8 mm. That is, the light-emitting module satisfies all the relations indicated by Expression (3), Expression (4), and Expression (5). In a measurement result of the experiment, the difference between the maximum value and the minimum value of the color temperature of the light output from the pipe 12 was 50 K and variance of a color was not conspicuous.

The next experiment is explained with reference to FIG. 10. FIG. 10 is a diagram for explaining the experiment. A difference between a maximum value and a minimum value of a color temperature in the longitudinal direction of the pipe 12 of light output from the pipe 12 was measured using a light-emitting module in which the light-emitting sections 45 including the two kinds of light-emitting elements, color temperatures of emitted lights of which were 3500 K and 5500 K, having a diameter (φ) of 5 mm and height of 1 mm were arranged in zigzag in the longitudinal direction of a substrate as shown in FIG. 10. In the light-emitting module, R=30 mm, d2=12 mm, and d1=8 mm. That is, the light-emitting module satisfies all the relations indicated by Expression (3), Expression (4), and Expression (5). In a measurement result of the experiment, the difference between the maximum value and the minimum value of the color temperature of the light output from the pipe 12 was 50 K and variance of a color was not conspicuous.

Judging from the above, when the relations of Expression (3), Expression (4), and Expression (5) are satisfied as in the lamp 11 according to the second embodiment, it is possible to suppress variance in a color of light emitted from the lamp 11. In particular, when a difference between color temperatures of lights respectively emitted from the two kinds of light-emitting elements 45a and 45b is equal to or larger than 1800 K, variance in a color is remarkably less conspicuous.

### Third Embodiment

A third embodiment is explained. The third embodiment is different from the first embodiment and the second embodiment in that, while the two kinds of light-emitting elements 45a and 45b are always lit, a color temperature of light obtained by mixing lights emitted from the two kinds of light-emitting elements 45a and 45b is controlled to reach a target color temperature. Concerning the other points, the third embodiment is the same as the first embodiment and the second embodiment. Therefore, explanation of the other points is omitted. In the following explanation, the light-emitting elements 45a and 45b and the resin 54a formed on the light-emitting elements 45a and 45b are collectively referred to as light-emitting elements 54a and 54b.

In this embodiment, the control circuit 3c controls luminous fluxes of respective lights emitted from the two kinds of light-emitting elements 45a and 45b in the light-emitting sections 45 and controls a color temperature of light obtained by mixing the lights emitted from the two kinds of light-emitting elements 45a and 45b to reach a target temperature (3500 K to 5500 K).

In this embodiment, for example, as shown in Table 1 below, the light-emitting elements 54a, a color temperature of emitted light of which is 3000 K lower than the target color temperature, and the light-emitting elements 54b, a color temperature of emitted light of which is 5800 K higher than the target color temperature, are used.

TABLE 1

| | | | Color specifications | | | |
|---|---|---|---|---|---|---|
| | COB color design | | (3500 K to 5500 K dimming) | | | |
| | value | | 3500 K | | 5500 K | |
| Color | | Current | Tc | Current | Tc | Current |
| classification | Tc [K] | ratio [%] | [K] | ratio [%] | [K] | ratio [%] |
| L color | 3000 | 100 | 3000 | 100 | 3000 | 10 |
| D color | 5800 | 100 | 5800 | 10 | 5800 | 100 |

A color, a color temperature of which corresponds to 3000 K, is referred to as “L color”. A color, a color temperature of which corresponds to 5800 K, is referred to as “D color”.

To control the color temperature of the light obtained by mixing the lights emitted from the two kinds of light-emitting elements 45a and 45b in the light-emitting sections 45 to reach 3500 K as shown in Table 1, the control circuit 3c performs control explained below. The control circuit 3c controls the first lighting circuit 3a such that a maximum current flows from the first lighting circuit 3a to the light-emitting element 45a and controls the second lighting circuit 3b such that 10% of the maximum current flows from the second lighting circuit 3b to the light-emitting element 45b. Consequently, the color temperature of the light obtained by mixing the lights emitted from the two kinds of light-emitting elements 45a and 45b reaches 3500 K.

To control the color temperature of the light obtained by mixing the lights emitted from the two kinds of light-emitting elements 45a and 45b in the light-emitting sections 45 to reach 5500 K as shown in Table 1, the control circuit 3c performs control explained below. The control circuit 3c controls the first lighting circuit 3a such that 10% of the maximum current flows from the first lighting circuit 3a to the light-emitting element 45a and controls the second lighting circuit 3b such that the maximum current flows from the second lighting circuit 3b to the light-emitting element 45b. Consequently, the color temperature of the light obtained by mixing the lights emitted from the two kinds of light-emitting elements 45a and 45b reaches 5500 K.

As explained above, in the lighting device 1 according to this embodiment, a color temperature of lights emitted by one kind of the light-emitting elements 45b of the two kinds of the light-emitting elements 45a and 45b in the light-emitting sections 45 is lower than the target color temperature and a color temperature of lights emitted by the other kind of the light-emitting elements 45a is higher than the target temperature. The control circuit 3c of the lighting device 1 controls, in a state in which none of the two kinds of light-emitting elements 45a and 45b are not extinguished and both the two kinds of light-emitting elements 45a and 45b are lit, luminous fluxes of lights respectively emitted from the two kinds of light-emitting elements 45a and 45b to control a color temperature of lights (mixed lights) emitted from the light-emitting sections 45 including the light-emitting elements 45a and 45b to the target color temperature. Therefore, with the lighting device 1, in a state in which none of the light-emitting elements are not extinguished and both the light-emitting elements are lit, a color temperature of light emitted from the lamp 11 is controlled. Therefore, it is possible to suppress variance in a color of the light emitted from the lamp 11.

As explained above, in the lamp 11 according to this embodiment, a color temperature of lights emitted by one kind of the light-emitting elements 45b of the two kinds of light-emitting elements 45a and 45b is lower than the target color temperature and a color temperature of lights emitted by the other kind of the light-emitting elements 45a is higher than the target temperature. In a state in which lights are emitted from both the two kinds of light-emitting elements 45a and 45b, luminous fluxes of lights respectively emitted from the two kinds of light-emitting elements 45a and 45b are controlled to control a color temperature of lights emitted from the light-emitting sections 45 including the light-emitting elements 45a and 45b to the target color temperature. Therefore, with the lamp 11 including the light-emitting sections 45 including the two kinds of light-emitting elements 45a and 45b, it is possible to suppress variance in color of light emitted from the lamp 11.

As explained above, according to the embodiments, it is possible to suppress variance in brightness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp comprising:
a substrate;
a plurality of light-emitting sections including a plurality of kinds of light-emitting elements provided side by side in a predetermined direction on the substrate and configured to respectively emit lights of different colors, luminous fluxes of the lights respectively emitted by the light-emitting elements being separately controllable; and
a pipe configured to diffuse the lights emitted by the light-emitting elements and formed including a translucent material, linear transmittance of which is any value of 0% to 50%, wherein
a distance from a lower part of the pipe to the light-emitting elements is larger than an inner radius of the pipe.

2. The lamp according to claim 1, wherein a distance between the light-emitting elements of a same kind that emit lights of a same color in different ones of the light-emitting sections is smaller than an inner diameter of the pipe.

3. The lamp according to claim 1, wherein
a difference between color temperatures of the lights respectively emitted from the plurality of kinds of light-emitting elements is equal to or larger than 1800 K, and
a distance between the plurality of kinds of light-emitting elements in the light-emitting sections is smaller than a distance between the light-emitting sections.

4. The lamp according to claim 3, wherein the distance between the light-emitting sections is smaller than a multiplication value of an outer diameter of the pipe and 0.6.

5. The lamp according to claim 1, wherein
the plurality of kinds of light-emitting elements are two kinds of the light-emitting elements,
a color temperature of lights emitted by one kind of the light-emitting elements of the two kinds of the light-emitting elements is lower than a predetermined color temperature, a color temperature of lights emitted by the other kind of the light-emitting elements is higher than the predetermined color temperature, and, in a state in which lights are emitted from both the light-emitting elements of the two kinds of light-emitting elements, when luminous fluxes of lights emitted from the respective light-emitting elements of the two kinds of light-emitting elements are controlled, a color temperature of the lights emitted from the light-emitting sections reaches the predetermined color temperature.

6. The lamp according to claim 5, wherein one kind of the light-emitting elements of the two kinds of light-emitting elements are connected to a first pole of a first power supply via a first wire and connected to a second pole via a second wire and the other kind of the light-emitting elements are connected to a first pole of a second power supply via a third wire and connected to the second pole via the second wire.

7. The lamp according to claim 6, wherein the first pole is a positive pole and the second pole is a negative pole.

8. The lamp according to claim 1, wherein the pipe is formed including a translucent material, linear transmittance of which is any value of 0% to 20%.

9. A luminaire comprising:
a lamp including a substrate, a plurality of light-emitting sections including a plurality of kinds of light-emitting elements provided side by side in a predetermined direction on the substrate and configured to respectively emit lights of different colors, luminous fluxes of the lights respectively emitted by the light-emitting elements being separately controllable, and a pipe configured to diffuse the lights emitted by the light-emitting elements and formed including a translucent material, linear transmittance of which is any value of 0% to 50%, a distance from a lower part of the pipe to the light-emitting elements being larger than an inner radius of the pipe; and
a lighting circuit connected to a power supply and configured to supply electric power to the lamp.

10. The luminaire according to claim 9, wherein a distance between the light-emitting elements of a same kind that emit lights of a same color in different ones of the light-emitting sections is smaller than an inner diameter of the pipe.

11. The luminaire according to claim 9, wherein
a difference between color temperatures of the lights respectively emitted from the plurality of kinds of light-emitting elements is equal to or larger than 1800 K, and
a distance between the plurality of kinds of light-emitting elements in the light-emitting sections is smaller than a distance between the light-emitting sections.

12. The luminaire according to claim 11, wherein the distance between the light-emitting sections (45) is smaller than a multiplication value of an outer diameter of the pipe (12) and 0.6.

13. The luminaire according to claim 9, wherein
the plurality of kinds of light-emitting elements are two kinds of the light-emitting elements,
a color temperature of lights emitted by one kind of the light-emitting elements of the two kinds of the light-emitting elements is lower than a predetermined color temperature, a color temperature of lights emitted by the other kind of the light-emitting elements is higher than the predetermined color temperature, and, in a state in which lights are emitted from both the light-emitting elements of the two kinds of light-emitting elements, when luminous fluxes of lights emitted from the respective light-emitting elements of the two kinds of light-emitting elements are controlled, a color temperature of the lights emitted from the light-emitting sections reaches the predetermined color temperature.

14. The luminaire according to claim 13, wherein one kind of the light-emitting elements of the two kinds of light-emitting elements are connected to a first pole of a first power supply via a first wire and connected to a second pole via a second wire and the other kind of the light-emitting elements are connected to a first pole of a second power supply via a third wire and connected to the second pole via the second wire.

15. The luminaire according to claim 14, wherein the first pole is a positive pole and the second pole is a negative pole.

16. The luminaire according to claim 9, wherein the pipe is formed including a translucent material, linear transmittance of which is any value of 0% to 20%.
